(19) United States
(12) Patent Application Publication
(10) Pub. No.: US 2021/0215108 A1
(43) Pub. Date: Jul. 15, 2021

(54) PARALLEL DIESEL ENGINE GENERATOR SYSTEM AND METHOD FOR CONTROLLING THE SAME

(71) Applicant: INNOBE CO., LTD., Uiwang-si, Gyeonggi-do (KR)

(72) Inventor: Seung Chul KIM, Yongin-si, Gyeonggi-do (KR)

(73) Assignee: INNOBE CO., LTD., Uiwang-si, Gyeonggi-do (KR)

(21) Appl. No.: 16/967,418

(22) PCT Filed: Jan. 9, 2019
(86) PCT No.: PCT/KR2019/000346

§ 371 Date: Aug. 5, 2020

(30) Foreign Application Priority Data
Feb. 6, 2018 (KR) 10-2018-0014300
May 21, 2018 (KR) 10-2018-0057931

(51) Int. Cl. F02D 29/06; F02B 63/04; H02J 3/38; H02J 3/46

(52) U.S. Cl. CPC F02D 29/06; F02B 63/04; H02J 2300/10; H02J 3/46; H02J 3/381

(57) ABSTRACT

A parallel diesel engine generator system includes a plurality of diesel engine generators connected in parallel, a distribution unit in which electric power generated in each of the diesel engine generators is collected and an external load is connected, engine output sensing units which sense an RPM at the output side of a diesel engine; automatic voltage regulators which are equipped in the generator; engine generator control units which connects an electronic control unit; and a system control unit which is connected to each of the engine generator control units of the diesel engine generators and connected to the distribution unit to distribute loads applied to the distribution unit in accordance with figures of merit of the diesel engine generators to control the engine generator control units.

### BACKGROUND OF THE INVENTION

### Field of the Invention

The present invention relates to a parallel diesel engine generator system and a method for controlling the same.

### Description of the Related Art

Due to sudden increase of electricity usage and difficulty of electricity production, necessity of self-power generation is increasing not only in Korea, but also globally.

Specifically, in Korea, electricity charge is added by a peak value and a weight is applied in accordance with the increase of a usage amount so that in some cases, the electricity charge is increased by at least five times as compared with a basic charge. Therefore, the necessity of self-power generation is increasing more and more. For the purpose of self-power generation, a generator using a diesel engine has been used in recent years.

The generator using a diesel engine is classified into a mechanical engine generator and an electronic engine generator.

The mechanical engine generator is cheaper than the electronic engine generator, but the mechanical engine generator has poor fuel economy and performance and it is difficult to meet regulatory standards for emission gas.

The electronic engine generator has excellent fuel economy and performance as compared with the mechanical engine generator and satisfies the regulatory standards for emission gas, but the electronic engine generator is expensive and the supply of the electronic engine generator is not sufficient.

In order to solve the above-mentioned problem, an electronic diesel engine generator which collects a diesel engine from a scrapped diesel vehicle is being developed. The electronic diesel engine generator is cheap and has excellent fuel economy and performance and meets the regulatory standards for emission gas.

In the meantime, in order to increase an output of the diesel engine generator, a parallel diesel engine generator system in which a plurality of diesel engine generators is connected in parallel is being developed. However, since diesel engines are collected from scrapped diesel vehicles to manufacture the diesel engine generator, when a plurality of diesel engine generators is connected, performances and lifetimes of individual scrapped diesel engines are different. Therefore, when a lifetime of one diesel engine generator is shortened or the performance thereof is rapidly deteriorated, the performance of the entire diesel engine generator cannot be exhibited.

### SUMMARY OF THE INVENTION

An aspect of the invention is to provide a parallel diesel engine generator system and a control method thereof which increase a generation efficiency output from diesel engine generators in which a plurality of diesel engine generators including a scrapped diesel engine is connected in parallel and maximize the lifetime of the diesel engine generators.

Another aspect of the present invention is to provide a parallel diesel engine generator system and a control method thereof which when a load is applied, directly output the load.

According to an aspect of the present invention, there is provided a parallel diesel engine generator system including: a plurality of diesel engine generators which includes a scrapped diesel engine collected from a scrapped common rail diesel vehicle and a generator which is connected to the scrapped diesel engine to generate electric power by the output of the scrapped diesel engine and is connected in parallel; a distribution unit which is connected to a common output line connected to the diesel engine generators and is connected to an external load; engine output sensing units which sense an RPM at the output side of a diesel engine configuring each of the diesel engine generators; automatic voltage regulators which are equipped in the generator configuring each of the diesel engine generators; engine generator control units which connect an electronic control unit configuring each of the diesel engine generators with the engine output sensing unit and the automatic voltage regulator to control the diesel engine generator; and a system control unit which is connected to each of the engine generator control units of the diesel engine generators and connected to the distribution unit to distribute loads applied to the distribution unit in accordance with figures of merit of the diesel engine generators to control the engine generator control units in which the figures of merit include an operation time of the scrapped diesel engine and a type of the scrapped diesel engine.

The engine generator control unit may include a first input unit to which data sensed by the electronic control unit of the scrapped diesel engine is input, a second input unit to which data sensed by the engine output sensing unit is input, a third input unit to which data sensed by the automatic voltage regulator of the generator is input, and a control unit which controls the electronic control unit of the scrapped diesel engine in accordance with the load distributed in the system control unit, based on the data input from the first, second, and third input units.

According to another aspect of the present invention, there is provided a control method of a parallel diesel engine generator system including: inputting each figure of merit of a plurality of diesel engine generators which includes a scrapped diesel engine collected from a scrapped common rail diesel vehicle and a generator connected to the scrapped diesel engine to generate electric power by the output of the scrapped diesel engine and is connected in parallel, to a system control unit; operating the plurality of diesel engine generators; sensing a load applied to the entire output side of the diesel engine generators; distributing the load in accordance with the figure of merit of each of the diesel engine generators when the load is equal to or higher than a set value to set an output load value of each diesel engine generator; and increasing an injector fuel injecting amount of a scrapped diesel engine configuring the diesel engine generator in accordance with the output load value set to each of the diesel engine generators in which the figure of merit includes an operation time of the scrapped diesel engine and a type of scrapped diesel engine until a diesel vehicle with the scrapped diesel engine mounted therein is scrapped.

The injector fuel injecting amount of the diesel engine may be increased by increasing an accelerator voltage to an electronic control unit of the diesel engine in accordance with the set output load value and increasing the injector fuel injection time of the diesel engine in accordance with the increase of the accelerator voltage.

The plurality of diesel engine generators connected in parallel may maintain 1450 to 1500 RPM or 1750 to 1850 RPM.

### BRIEF DESCRIPTION OF THE DRAWING

The above and other aspects, features and other advantages of the present invention will be more clearly understood from the following detailed description taken in conjunction with the accompanying drawings, in which:

FIG. 1 is a block diagram illustrating an exemplary embodiment of a parallel diesel engine generator system according to the present invention;

FIG. 2 is a block diagram illustrating a scrapped diesel engine which configures an exemplary embodiment of a parallel diesel engine generator system according to the present invention;

FIG. 3 is a block diagram illustrating an engine generator control unit which configures an exemplary embodiment of a parallel diesel engine generator system according to the present invention; and

FIG. 4 is a flowchart illustrating an exemplary embodiment of a control method of a parallel diesel engine generator system according to the present invention.

### DETAILED DESCRIPTION OF THE PREFERRED EMBODIMENT

Hereinafter, exemplary embodiments of a parallel diesel engine generator system and a control method thereof will be described with reference to accompanying drawings.

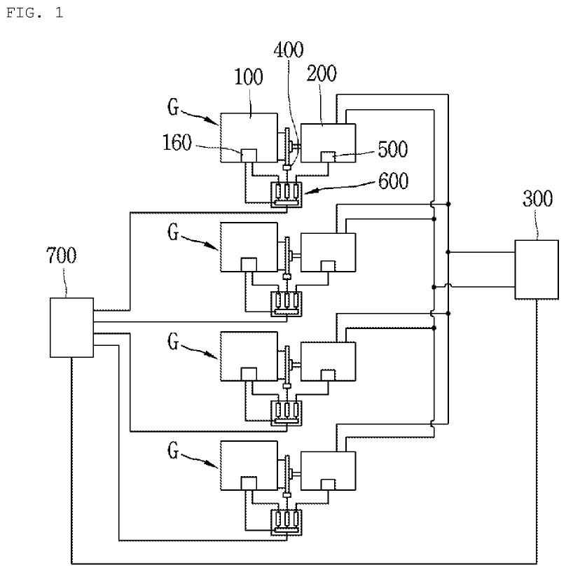

FIG. 1 is a block diagram illustrating an exemplary embodiment of a parallel diesel engine generator system according to the present invention.

As illustrated in FIG. 1, an exemplary embodiment of a parallel diesel engine generator system according to the present invention includes a plurality of diesel engine generators G which is connected in parallel, a distribution unit 300, engine output sensing units 400, automatic voltage regulators 500, engine generator control units 600, and a system control unit 700.

The diesel engine generator G includes a scrapped diesel engine 100 collected from a scrapped diesel vehicle and a generator 200 which is connected to the scrapped diesel engine 100 to generate electric power by the output of the scrapped diesel engine 100.

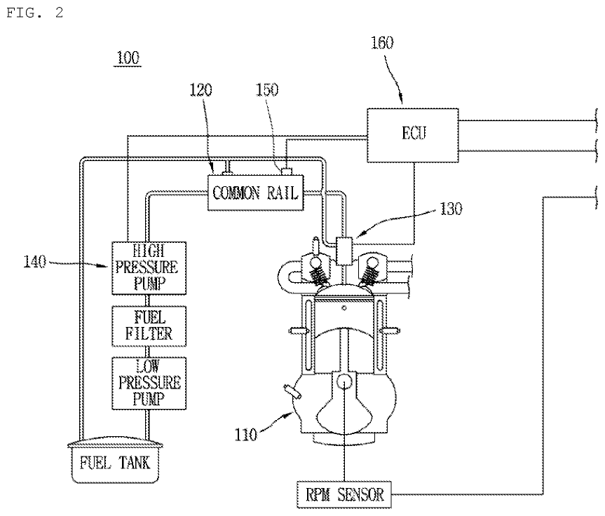

The scrapped diesel engine 100 is collected from a scrapped common rail diesel vehicle. As illustrated in FIG. 2, the scrapped diesel engine 100 includes an engine body 110, a common rail 120, an injector 130, a high pressure fuel pump 140, a fuel pressure sensor 150, and an electronic control unit (ECU) 160. The fuel pressure sensor 150 senses a fuel pressure in the common rail 120 to provide fuel pressure data in the common rail 120 to the electronic control unit 160. The electronic control unit 160 is an electronic control unit 160 of a diesel vehicle in which the common rail 120 is mounted and has an air flow rate, an engine RPM, a throttle position sensor (TPS) signal, an air temperature, and a fuel pressure signal of the common rail 120 as inputs and has an open/close time control signal of the injector 130 and an open control signal of the injector 130 through PID control as outputs. That is, when data such as the engine RPM and the air flow rate is given, the electronic control unit 160 adjusts a fuel pressure of the common rail 120 by an injection pressure determining map according to data such as an air flow rate/engine RMP and the fuel pressure sensor 150 measures a fuel pressure in the common rail 120 to transmit a measured value to the electronic control unit 160. By doing this, the electronic control unit 160 compares a fuel pressure measured in the common rail 120 with a target fuel pressure to control the open/close time and an opening amount of the injector to cause two pressures (the measured pressure of the common rail and the target fuel pressure) to be equal.

The generator 200 is an induction generator which is a known generator 200.

Generator output lines 1 connected to individual generators of the plurality of diesel engine generator are connected to a common output line (also referred to as a bus) 2 so that the plurality of diesel engine generators G is connected in parallel.

The distribution unit 300 is connected to the common output line 2 to which the diesel engine generators G are connected in parallel. Further, an external load is connected to the distribution unit 300. That is, the load connected to the distribution unit 300 may be a refrigerator, an air conditioner, or a pump.

The engine output sensing unit 400 senses an RPM at an output side of the scrapped diesel engine 100 which configures the diesel engine generator G. The engine output sensing unit 400 transmits an RPM value sensed at the output side of the scrapped diesel engine 100 to the engine generator control unit 600.

The automatic voltage regulator 500 is equipped in a generator 200 which configures each diesel engine generator G of the diesel engine generators G. The automatic voltage regulator (AVR) 500 includes a current meter which measures a current generated in the generator 200, a voltage meter which measures a voltage generated in the generator 200, and a frequency meter which measures a frequency generated in the generator 200. The current meter measures a current generated in the generator 200 and transmits the measured current value to the engine generator control unit 600. The voltage meter measures a voltage generated in the generator 200 and transmits the measured voltage value to the engine generator control unit 600. The frequency meter measures a frequency generated in the generator 200 and transmits the measured frequency value to the engine generator control unit 600.

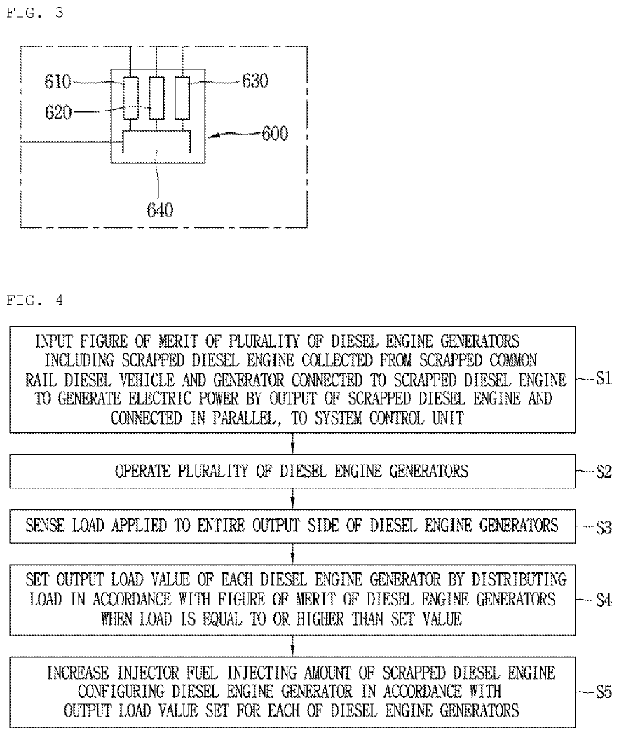

The engine generator control unit 600 controls the diesel engine generator G by connecting the electronic control unit 160 configuring each diesel engine generator G of the diesel engine generators G to the engine output sensing unit 400 and the automatic voltage regulator 500. As an example of the engine generator control unit 600, as illustrated in FIG. 3, the engine generator control unit 600 includes a first input unit 610 to which data sensed by the electronic control unit 160 of the scrapped diesel engine 100 is input, a second input unit 620 to which data sensed by the engine output sensing unit 400 is input, a third input unit 630 to which data sensed by the automatic voltage regulator 500 of the generator 200 is input, and a control unit 640 which controls the electronic control unit 160 of the scrapped diesel engine 100 when a load is applied to the generator 200, based on data input from the first, second, and third input units 610, 620, and 630.

The engine generator control units 600 of the diesel engine generators G are connected to the system control unit 700 and the distribution unit 300 is also connected thereto. The system control unit 700 distributes loads applied to the distribution unit 300 in accordance with figures of merit of the diesel engine generators G to control the engine generator control unit 600. The figure of merit includes an operation time (a driving distance of the diesel vehicle before being scrapped) of the scrapped diesel engine 100, a type of the scrapped diesel engine 100, and a worn amount of a component of the engine body 110 of the scrapped vehicle engine 100.

FIG. 4 is a flowchart illustrating an exemplary embodiment of a control method of a parallel diesel engine generator system according to the present invention.

As illustrated in FIG. 4, according to an exemplary embodiment of a control method of a parallel diesel engine generator system according to the present invention, first, a step S1 of inputting each figure of merit of a plurality of diesel engine generators G connected in parallel to a system control unit 700 is performed. The plurality of diesel engine generators G includes a scrapped diesel engine 100 collected from a scrapped common rail diesel vehicle and a generator 200 which is connected to the scrapped diesel engine 100 to generate electric power by the output of the scrapped diesel engine 100. The system control unit 700 controls the plurality of diesel engine generators G. The figure of merit may be an operation time of the scrapped diesel engine 100, a type of the scrapped diesel engine 100, and a worn amount of an engine body of the diesel engine.

After inputting each figure of merit of the diesel engine generators G, a step S2 of operating the plurality of diesel engine generators G by the system control unit 700 is performed. Each scrapped diesel engine 100 of the diesel engine generators G may desirably maintain 1450 to 1500 RPM or 1750 to 1850 RMP at which the efficiency is maximized.

After operating the diesel engine generators G, a step S3 of sensing loads applied to the entire output sides of the diesel engine generators G is performed.

After sensing the loads of the diesel engine generators G, when the load is equal to or higher than a set value, a step S4 of setting an output load value of each diesel engine generator G by distributing the loads in accordance with the figures of merit of the diesel engine generators G is performed.

After setting the output load value of each diesel engine generator G, a step S5 of increasing an injector fuel injecting amount of the scrapped diesel engine 100 which configures the diesel engine generator G in accordance with the output load value set for each diesel engine generator G of the diesel engine generators G is performed.

The injector fuel injecting amount of the scrapped diesel engine 100 is increased by increasing an accelerator voltage to the electronic control unit 160 of the scrapped diesel engine 100 in accordance with the set output load value and increasing the injector fuel injection time of the scrapped diesel engine 100 as the accelerator voltage is increased. When the fuel injection time of the injector 130 is increased in accordance with the output load value set in the diesel engine generator G, the output of the diesel engine 100 is controlled to be increased without reducing the RPM at the output side of the scrapped diesel engine 100. It is desirable that the plurality of diesel engine generators G connected in parallel outputs the distributed load value and each scrapped diesel engine 100 maintains 1450 to 1500 RPM or 1750 to 1850 RPM.

Hereinafter, an operation and an effect of a parallel diesel engine generator system and a control method thereof according to the present invention will be described.

First, the plurality of diesel engine generators G connected in parallel operates by the system control unit 700. When the diesel engine generators G connected in parallel individually operate, the scrapped diesel engine 100 of each diesel engine generator G outputs at a reference RPM to produce the electric power in the generator 200. The RPM output at the output side of the scrapped diesel engine 100 is sensed by the engine output sensing unit 400 to be transmitted to the engine generator control unit 600 and the voltage output by the generator 200 is uniformly regulated by the automatic voltage regulator 500 and the voltage value is transmitted to the engine generator control unit 600. The engine generator control unit 600 controls the electronic control unit 160 of the scrapped diesel engine 100 of the diesel engine generator G based on such data to maintain the output side of the scrapped diesel engine 100 at a set RPM which is the optimal efficiency, that is, 1450 to 1500 RPM or 1750 to 1850 RPM. The electric power produced in each diesel engine generator G of the plurality of diesel engine generators G is output to the distribution unit 300 through the generator output line 1 and the common output line 2 and the electric power output to the distribution unit 300 is supplied to the loads connected to the distribution unit 300, such as a refrigerator or a washing machine. In this case, the electric power output to the distribution unit 300 is sensed by the system control unit 700.

In the meantime, when an electric heater or a pump is additionally connected to the distribution unit 300 so that an overload which is higher than a reference load is applied to the distribution unit 300, the system control unit 700 senses the overload and the system control unit 700 distributes the overload in accordance with each figure of merit of the diesel engine generators G in order to increase the entire output of the plurality of diesel engine generators G and transmits the distributed load value to the engine generator control unit 600 of each diesel engine generator G. The engine generator control unit 600 of each diesel engine generator G controls the electronic control unit 160 in accordance with the distributed load value to increase the fuel injection time of the injector 130 of the scrapped diesel engine 100, thereby increasing a fuel injecting amount which is injected to the scrapped diesel engine 100. For example, when four diesel engine generators G are connected in parallel and four diesel engine generators G are referred to as first, second, third, and fourth diesel engine generators, the figures of merit of the scrapped diesel engines 100 are determined to be 30, 20, 20, and 30 in the order of excellent levels in accordance with the operation time (driving distance) and the type of diesel engine 100 and when the load is 180, the loads of the first, second, third, and fourth diesel engine generators G are 53, 36, 36, and 54, respectively. When the distributed load is input to the engine generator control unit 600 of each diesel engine generator G of the first, second, third, and fourth diesel engine generator, the engine generator control unit 600 controls the electronic control unit 160 in accordance with the distributed load to increase the fuel injecting amount of the injector 130 in the scrapped diesel engine 100. In this case, the fuel injecting amount injected to the scrapped diesel engine 100 may be desirably increased by increasing the accelerator voltage of the electronic control unit 160 of the scrapped diesel engine 100 in accordance with the set output load value and increasing the injector fuel injection time of the scrapped diesel engine 100 in accordance with the increase of the accelerator voltage. The output side of the scrapped diesel engine 100 of each diesel engine generator G is maintained at the set RPM. The RPM of the output side of the scrapped diesel engine 100 is consistently sensed by the engine output sensing unit 400 to be transmitted to the engine generator control unit 600 and the electric power generated in the generator 200 is sensed by the automatic voltage regulator 500 to be transmitted to the engine generator control unit 600. The output is increased in accordance with the load which is distributed in the diesel engine generators G connected in parallel so that the electric power suitable for the overload connected to the distribution unit 300 may be supplied. The output generated in each of the diesel engine generators G synchronizes the voltage and a frequency.

As described above, according to the present invention, a plurality of diesel engine generators G each including a scrapped diesel engine 100 and a generator 200 is connected in parallel and the diesel engine generators G operate in accordance with the figure of merit of each scrapped diesel engine 100 of the diesel engine generators G so that the diesel engine generators G efficiently operate in accordance with the performance and the lifetime of the entire diesel engine generator system is extended.

Further, according to the present invention, when the output of the diesel engine generator G is increased in accordance with the distributed load, the fuel injection time of the injector 130 of the diesel engine 100 is increased to increase the fuel injecting amount injected into the diesel engine 100 so that the output of the scrapped diesel engine 100 of the diesel engine generator G is sharply increased. By doing this, the load distributed to the generator 200 is immediately output so that reduction of the RPM of the scrapped diesel engine 100 and the reduction of the output of the generator 200 in accordance with the distributed load are prevented to enhance the efficiency of the diesel engine generator G.

What is claimed is:

1. A parallel diesel engine generator system, comprising:
a plurality of diesel engine generators which includes a scrapped diesel engine collected from a scrapped common rail diesel vehicle and a generator which is connected to the scrapped diesel engine to generate electric power by the output of the scrapped diesel engine and is connected in parallel;
a distribution unit which is connected to a common output line connected to the diesel engine generators and is connected to an external load;
engine output sensing units which sense an RPM at the output side of a diesel engine configuring each of the diesel engine generators;
automatic voltage regulators which are equipped in the generator configuring each of the diesel engine generators;
engine generator control units which connect an electronic control unit configuring each of the diesel engine generators with the engine output sensing unit and the automatic voltage regulator to control the diesel engine generator; and
a system control unit which is connected to each of the engine generator control units of the diesel engine generators and connected to the distribution unit to distribute loads applied to the distribution unit in accordance with figures of merit of the diesel engine generators to control the engine generator control units,
wherein the figures of merit include an operation time of the scrapped diesel engine and a type of the scrapped diesel engine.

2. The parallel diesel engine generator system according to claim 1, wherein the engine generator control unit includes a first input unit to which data sensed by the electronic control unit of the scrapped diesel engine is input, a second input unit to which data sensed by the engine output sensing unit is input, a third input unit to which data sensed by the automatic voltage regulator of the generator is input, and a control unit which controls the electronic control unit of the scrapped diesel engine in accordance with the load distributed in the system control unit, based on the data input from the first, second, and third input units.

3. A control method of a parallel diesel engine generator system, comprising:
inputting each figure of merit of a plurality of diesel engine generators which includes a scrapped diesel engine collected from a scrapped common rail diesel vehicle and a generator connected to the scrapped diesel engine to generate electric power by the output of the scrapped diesel engine and is connected in parallel, to a system control unit;
operating the plurality of diesel engine generators;
sensing a load applied to the entire output side of the diesel engine generators;
distributing the load in accordance with the figure of merit of each of the diesel engine generators when the load is equal to or higher than a set value to set an output load value of each diesel engine generator; and
increasing an injector fuel injecting amount of a scrapped diesel engine configuring the diesel engine generator in accordance with the output load value set to each of the diesel engine generators,
wherein the figure of merit includes an operation time of the scrapped diesel engine and a type of scrapped diesel engine until a diesel vehicle with the scrapped diesel engine mounted therein is scrapped.

4. The control method according to claim 3, wherein the injector fuel injecting amount of the diesel engine is increased by increasing an accelerator voltage to an electronic control unit of the diesel engine in accordance with the set output load value and increasing the injector fuel injection time of the diesel engine in accordance with the increase of the accelerator voltage.

5. The control method according to claim 3, wherein the plurality of diesel engine generators connected in parallel maintains 1450 to 1500 RPM or 1750 to 1850 RPM.
